(19) United States
(12) Patent Application Publication
(10) Pub. No.: US 2024/0425964 A1
(43) Pub. Date: Dec. 26, 2024

(54) THERMAL SPRAYING EQUIPMENT AND THERMAL SPRAYING CONTROL METHOD

(71) Applicant: NHK SPRING CO., LTD., Yokohama-shi (JP)

(72) Inventors: Hibiki YOKOYAMA, Yokohama-shi (JP); Noriyoshi KANEDA, Yokohama-shi (JP); Michiyoshi SONE, Yokohama-shi (JP); Satoshi HIRANO, Yokohama-shi (JP); Go TAKAHARA, Yokohama-shi (JP); Takatoshi NAMBU, Yokohama-shi (JP)

(21) Appl. No.: 18/826,386

(22) Filed: Sep. 6, 2024

Related U.S. Application Data
(63) Continuation of application No. PCT/JP2023/007043, filed on Feb. 27, 2023.

(30) Foreign Application Priority Data
Mar. 9, 2022 (JP) 2022-036190

(51) Int. Cl. C23C 4/18

(52) U.S. Cl. CPC C23C 4/18

(57) ABSTRACT

According to an embodiment of the present invention, a thermal spraying equipment including a thermal spraying machine including a thermal spraying torch thermally spraying a material onto a base material, a thermal spraying booth where thermal spraying machine is arranged, one or more peripheral devices used with the thermal spraying machine, a safety door separating an inside and an outside of the thermal spraying booth, and a centralized control board arranged outside of the thermal spraying booth, the centralized control board enabling centralized operation of the thermal spraying machine and the one or more peripheral devices. The centralized control board controls the spraying machine not to be driven in the case where the safety door is not locked normally.

### CROSS-REFERENCE TO RELATED APPLICATIONS

This application is a Continuation of International Patent Application No. PCT/JP2023/007043, filed on Feb. 27, 2023, which claims the benefit of priority to Japanese Patent Application No. 2022-036190, filed on Mar. 9, 2022, the entire contents of which are incorporated herein by reference.

### FIELD

An embodiment of the present disclosure relates to a thermal spraying equipment and a thermal spraying control method.

### BACKGROUND

A thermal spraying device is known in which a film forming material such as a metal or a ceramic is heated to be melted or brought into a state close to melting (semi-melting), and the film forming material that is melted or brought into the semi-melting state is sprayed onto a base material, thereby forming a film of the film forming material on the base material. For example, Japanese Examined Utility Model Application Publication No. H5-29092 describes a thermal spray device.

### SUMMARY

A thermal spraying equipment according to an embodiment of the present disclosure includes a thermal spraying machine including a thermal spraying torch thermally spraying a material onto a base material; a thermal spraying booth where thermal spraying machine is arranged; one or more peripheral devices used with the thermal spraying machine; a safety door separating an inside and an outside of the thermal spraying booth; and a centralized control board arranged outside of the thermal spraying booth, the centralized control board enabling centralized operation of the thermal spraying machine and the one or more peripheral devices, wherein the centralized control board controls the spraying machine not to be driven in the case where the safety door is not locked normally.

A thermal spraying control method according to an embodiment of the present disclosure is a thermal spraying method performed by a thermal spraying machine including a thermal spraying torch spraying a material to a base material, a thermal spraying booth where thermal spraying machine is arranged, one or more peripheral devices used with the thermal spraying machine, a safety door separating an inside and an outside of the thermal spraying booth, and a centralized control board arranged outside of the thermal spraying booth, the thermal spraying control method comprising: collectively controlling the thermal spraying machine and the one or more peripheral devices using the centralized control board; and controlling the thermal spraying machine not to be driven in the case where the safety door is not locked normally.

### BRIEF DESCRIPTION OF DRAWINGS

FIG. 1 is a diagram for explaining a configuration of a thermal spraying equipment according to an embodiment of the present disclosure.

FIG. 2 is a block diagram for explaining an example of a configuration of a centralized control board according to an embodiment.

FIG. 3 is a flow diagram showing an example of a thermal spraying process performed by a thermal spraying equipment according to an embodiment.

FIG. 4 is a flow diagram showing an example of a thermal spraying process performed by a thermal spraying equipment according to an embodiment.

### DESCRIPTION OF EMBODIMENTS

In a thermal spraying process, in addition to a thermal spraying equipment including a thermal spraying torch that sprays a film forming material onto a base material, peripheral devices including a robot that moves the thermal spraying torch, a rotary machine that fixes and rotates the base material, an air feeding device that controls temperature and humidity in a thermal spraying booth, one or more sensors including a thermo-hygrometer that detects temperature and humidity in the thermal spraying booth, an oxygen concentration meter that detects oxygen concentration, a radiation thermometer that detects temperature of a product, a cooling device that cools the product, a dust collecting device that collects dust generated in the thermal spraying booth, and the like are operated.

The thermal spraying equipment and its peripheral devices had to be manually operated at the site by workers engaged in thermal spraying operation. Therefore, there is a problem that the thermal spraying operation becomes complicated and the operation efficiency is lowered. There was also a problem in the safety of workers at the site.

According to an embodiment of the present disclosure, it is possible to provide a thermal spraying equipment and a thermal spraying control method capable of reducing the complexity of a thermal spraying operation and improving the safety of the operation.

Hereinafter, embodiments of the present disclosure will be described with reference to the drawings and the like. However, the present invention can be implemented in many different aspects, and should not be construed as being limited to the description of the embodiments exemplified below. In order to make the description clearer, the drawings may be schematically represented with respect to the width, thickness, shape, and the like of each part as compared with the actual embodiment, but are merely examples, and do not limit the interpretation of the present disclosure. In addition, in the present specification and the drawings, the same or similar elements as those already described with respect to the drawings already described are denoted by the same reference signs (or numbers are followed by a, b, A, B, and the like), and detailed description thereof may be omitted as appropriate. Furthermore, the letters “first” and “second” with respect to the respective elements are convenient signs used to distinguish the respective elements, and do not have any further meaning unless otherwise specified.

In the drawings, although the widths, thicknesses, shapes, and the like of the respective portions may be schematically represented in comparison with the actual embodiments for clarity of explanation, the drawings are merely examples, and do not limit the interpretation of the present invention. In addition, in the present specification and the drawings, elements having the same functions as those described with respect to the drawings already described are denoted by the same reference signs, and redundant description thereof may be omitted.

As used herein, in the case where a member or region is referred to as being “above (or below)” another member or region, this includes not only the case where it is directly above (or directly below) the other member or region, unless otherwise limited, but also the case where it is above (or below) the other member or region, that is, the case where another component is included between the other member or region.

Also, in the present specification, expressions “a includes A, B, or C,” “a includes any of A, B, or C,” “a includes one selected from a group consisting of A, B, and C,” and the like does not exclude cases where a includes a plurality of combinations of A to C unless otherwise specified. Furthermore, these expressions do not exclude the case where a includes other elements.

### [Thermal Spraying Equipment]

Hereinafter, a thermal spraying equipment 10 according to an embodiment of the present disclosure will be described with reference to the drawings.

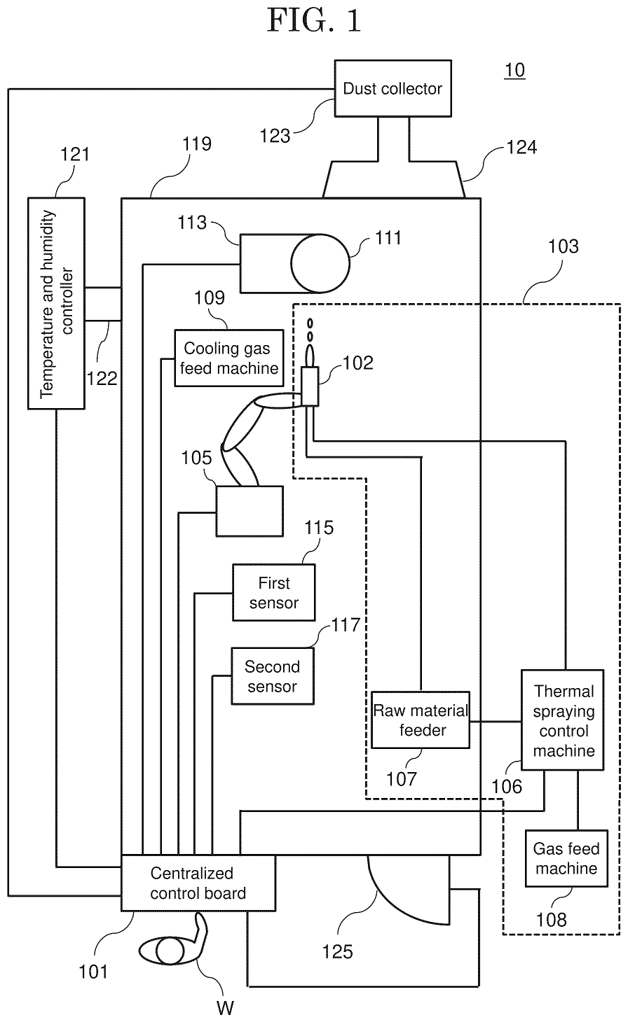

FIG. 1 is a diagram for explaining a configuration of the thermal spraying equipment 10 according to an embodiment of the present disclosure. The thermal spraying equipment 10 includes a centralized control board 101, a thermal spraying machine 103, and peripheral devices. The peripheral devices include a mover 105, a cooling gas feed machine 109, a rotary machine 113 including a workpiece (base material) 111, a first sensor 115, and a second sensor 117. The peripheral devices may include a temperature and humidity controller 121 and a dust collector 123. In the present embodiment, the thermal spraying machine 103 includes a thermal spraying torch 102, a thermal spraying control machine 106, a raw material feeder 107, and a gas feed machine 108.

In the present embodiment, at least a part of the thermal spraying machine 103, the mover 105, the cooling gas feed machine 109, the rotary machine 113, the first sensor 115, and the second sensor 117 are provided in a thermal spraying booth 119 in which a thermal spraying process is performed. The temperature and humidity controller 121 has an air duct 122 that connects into the thermal spraying booth 119. The dust collector 123 has an exhaust duct 124 connecting into the thermal spraying booth 119. Further, the thermal spraying equipment 10 includes a safety door 125 that allows a worker W to enter and exit the inside and outside of the thermal spraying booth 119.

The centralized control board 101 is installed outside the thermal spraying booth 119. The centralized control board 101 enables the respective components of the thermal spraying equipment 10 to be operated collectively. That is, the centralized control board 101 collectively controls operations of the thermal spraying machine 103, the mover 105, the cooling gas feed machine 109, the rotary machine 113, the first sensor 115, the second sensor 117, the temperature and humidity controller 121, and the dust collector 123. The centralized control board 101 receives an input operation by the worker W, controls the operation of each component of the thermal spraying equipment 10, and executes the thermal spraying process in the thermal spraying booth 119. The centralized control board 101 may control opening and closing of the safety door 125.

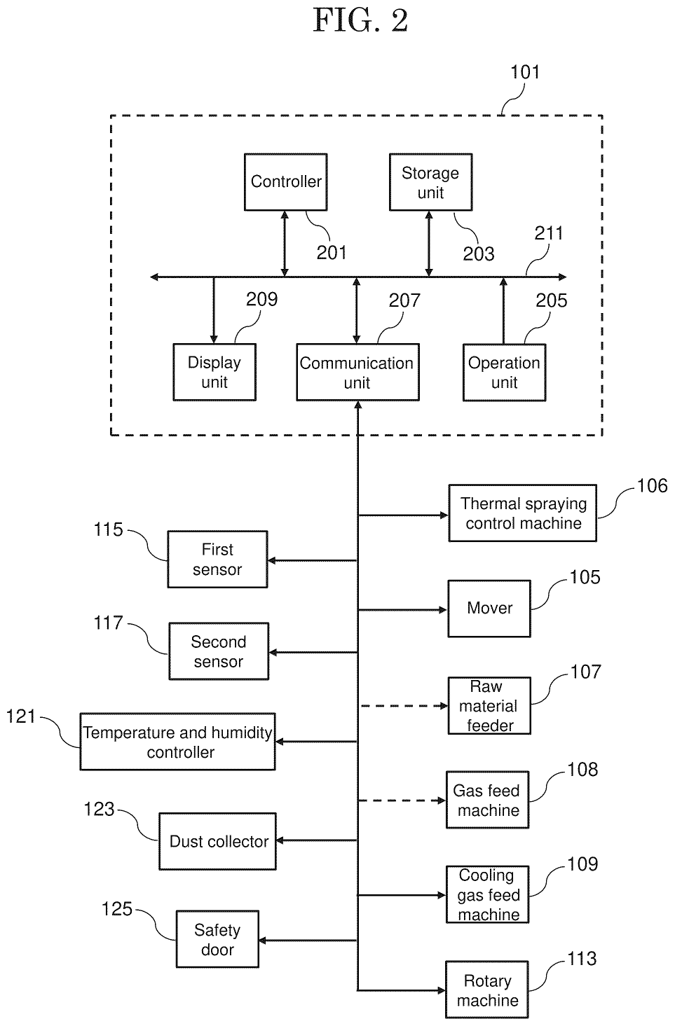

FIG. 2 is a block diagram for explaining an example of a configuration of the centralized control board 101 according to the present embodiment. The centralized control board 101 may include a controller 201, a storage unit 203, an operation unit 205, a communication unit 207, and a display unit 209. The controller 201, the storage unit 203, the operation unit 205, the communication unit 207, and the display unit 209 are connected to each other by a bus 211.

The controller 201 includes an arithmetic processor such as a CPU. The controller 201 executes a control program stored in the storage unit 203 by the CPU to control the operation of the thermal spraying equipment 10 to realize the thermal spraying process by the thermal spraying equipment 10. In other words, the controller 201 centrally controls the operations of the thermal spraying machine 103, the mover 105, the cooling gas feed machine 109, the rotary machine 113, the first sensor 115, the second sensor 117, the temperature and humidity controller 121, and the dust collector 123 constituting the thermal spraying equipment 10.

The storage unit 203 is a storage device such as a ROM, a RAM or a hard disk. The storage unit 203 stores a control program for realizing the thermal spraying process by the thermal spraying equipment 10. The control program may be provided in a state of being stored in a computer-readable recording medium such as a magnetic recording medium, an optical recording medium, a magneto-optical recording medium, or a semiconductor memory. In this case, the centralized control board 101 may be provided with a device for reading a recording medium. Further, the storage unit 203 may store settings of the thermal spraying machine 103, the mover 105, the cooling gas feed machine 109, the rotary machine 113, the first sensor 115, the second sensor 117, the temperature and humidity controller 121, and the dust collector 123, which constitute the thermal spraying equipment 10. The control program and the setting of each configuration of the thermal spraying equipment 10 may be downloaded via a network such as the Internet.

The operation unit 205 is a device such as an operation panel, an operation button, and a touch panel, and outputs a signal corresponding to the input operation to the controller 201. The worker W engaged in the thermal spraying operation controls the operation of the thermal spraying equipment 10 via the operation unit 205. The worker W can instruct the start and stop of the thermal spraying process performed by the thermal spraying equipment 10 via the operation unit 205. Further, the worker W can appropriately change the settings of the thermal spraying machine 103, the mover 105, the cooling gas feed machine 109, the rotary machine 113, the first sensor 115, the second sensor 117, the temperature and humidity controller 121, the dust collector 123, and the like, which constitute the thermal spraying equipment 10 via the operation unit 205.

The communication unit 207 performs communication with the respective components of the thermal spraying equipment 10, that is, the thermal spraying machine 103, the mover 105, the cooling gas feed machine 109, the rotary machine 113, the first sensor 115, the second sensor 117, the temperature and humidity controller 121, and the dust collector 123, based on the control of the controller 201. The communication may be wired communication or wireless communication. In addition, the function of the storage unit 203 may be realized by an external device that can communicate with the communication unit 207.

The display unit 209 is a display device such as a liquid crystal display or an organic EL display. On the display unit 209, a screen based on the control by the controller 201 is displayed to the worker W based on the control by the controller 201. For example, the display unit 209 may display setting states and operating states of the thermal spraying machine 103, the mover 105, the cooling gas feed machine 109, the rotary machine 113, the first sensor 115, the second sensor 117, the temperature and humidity controller 121, and the dust collector 123, and detection results of the first sensor 115 and the second sensor 117.

Returning to the description of the thermal spraying equipment 10 with reference to FIG. 1. The thermal spraying machine 103 includes the spraying torch 102 coupled to the mover 105 described below. The thermal spraying torch 102 injects a thermal spray material supplied from the raw material feeder 107 and gas supplied from the gas feed machine 108 through the thermal spraying control machine 106. The thermal spraying by the thermal spraying machine 103 may be gas thermal spraying including flame spraying and high-speed flame spraying, and may be electric thermal spraying including arc spraying and plasma spraying. The thermal spraying torch 102 melts or semi-melts the thermal spray material by gas or electricity (arc or plasma) to generate thermal spray particles. The thermal spraying torch 102 accelerates the generated thermal spray particles by gas such as compressed air, and sprays the generated thermal spray particles onto the workpiece 111 of the rotary machine 113 to form a coating film of the thermal spray particles on a surface of the workpiece 111.

The mover 105 moves the thermal spraying torch 102 based on the control of the controller 201. The mover 105 may be, for example, an industrial robot. Specifically, the mover 105 may be a six-axis or seven-axis vertical articulated robot. The mover 105 controls movements of the thermal spraying torch 102 in the front, rear, up, down, left, and right directions, an angle of the thermal spraying torch 102 relative to the surface of the workpiece 111 of the rotary machine 113, and the like, based on the control of the controller 201. For example, when the thermal spraying process by the thermal spraying machine 103 is started, the mover 105 may move the thermal spraying torch 102 so that the thermal spraying torch 102 approaches the workpiece 111 of the rotary machine 113, and tilt the thermal spraying torch 102 at a predetermined angle relative to the surface of the workpiece 111. Also, when the thermal spraying process is completed, the mover 105 may move the thermal spraying torch 102 away from the rotary machine 113.

The thermal spraying control machine 106 adjusts a supply amount of the thermal spray material supplied from the raw material feeder 107 to the thermal spraying torch 102 based on the control by the controller 201 of the centralized control board 101. Similarly, the thermal spraying control machine 106 adjusts a supply amount of working gas supplied from the gas supplier 108 based on the control by the controller 201 of the centralized control board 101, and supplies the working gas to the thermal spraying torch 102. In an embodiment, the supply amount of thermal spray material supplied from the raw material feeder 107 to the thermal spraying torch 102 may be adjusted directly by the controller 201 of the centralized control board 101. Similarly, in an embodiment, the supply amount of the working gas supplied from the gas feed machine 108 may be adjusted directly by the controller 201 of the centralized control board 101. In such a case, the thermal spraying control machine 106 may be omitted.

The raw material feeder 107 supplies the thermal spray material to the thermal spraying torch 102 at a predetermined flow rate based on the control of the thermal spraying control machine 106. The thermal spray material may be metal, ceramic, polymer, a composite material such as cermet, or the like. In the present embodiment, although the raw material feeder 107 is installed in the thermal spraying booth 119, at least a part of the raw material feeder 107 may be provided outside the thermal spraying booth 119. The supply amount of the thermal spray material supplied from the raw material feeder 107 to the thermal spraying torch 102 may be directly controlled by the controller 201 of the centralized control board 101.

The gas feed machine 108 supplies the working gas to the thermal spraying torch 102 through the thermal spraying control machine 106 at a predetermined flow rate based on the control of the thermal spraying control machine 106. In the case where the thermal spraying by the thermal spraying machine 103 is gas spraying, the working gas may be a mixed gas including oxygen (O₂) and acetylene. Further, in the case where the thermal spraying by the thermal spraying machine 103 is electric thermal spraying, the working gas may be a gas such as argon (Ar), helium (He), nitrogen (N₂), or hydrogen (H₂). A supply amount of the working gas supplied from the gas feed machine 108 may be directly controlled by the controller 201 of the centralized control board 101.

The cooling gas feed machine 109 supplies the cooling gas to the workpiece 111 of the rotary machine 113 at a predetermined flow rate based on the control of the controller 201. The cooling gas may be a nitrogen (N₂) gas or an argon (Ar) gas. The cooling gas supplied from the cooling gas feed machine 109 cools a thermal sprayed film formed on the surface of the workpiece 111.

The rotary machine 113 includes the workpiece 111. The rotary machine 113 rotates the workpiece 111 at a predetermined speed based on the control of the controller 201. The rotary machine 113 can also rotate the workpiece 111 at a predetermined angle based on the control of the controller 201. The thermal sprayed film is formed on the surface of the workpiece 111 by the thermal spray material sprayed from the thermal sprayed torch 102.

The first sensor 115 measures surface temperature of the workpiece 111 based on the control of the controller 201. The first sensor 115 may be, for example, a radiation temperature sensor. The first sensor 115 transmits the measured surface temperature of the workpiece 111 to the controller 201. The controller 201 controls the cooling gas feed machine 109 to supply the cooling gas to the surface of the workpiece 111 so that the temperature of the surface of the workpiece 111 is lowered to a predetermined temperature based on the surface temperature of the workpiece 111 acquired from the first sensor 115.

The second sensor 117 measures temperature and humidity in the thermal spraying booth 119 based on the control of the controller 201. The second sensor 117 may be a temperature and humidity sensor. The second sensor 117 transmits the measured temperature and humidity in the thermal spraying booth 119 to the controller 201. The controller 201 controls the temperature and humidity controller 121 in order to keep the inside of the thermal spraying booth 119 at a predetermined temperature and humidity based on the temperature and humidity in the thermal spraying booth 119 acquired from the second sensor 117.

The temperature and humidity controller 121 adjusts the temperature and humidity in the thermal spraying booth 119 based on the control of the controller 201.

The dust collector 123 collects dust generated in the thermal spraying booth 119 based on the control of the controller 201. The dust collector 123 discharges the collected dust to the outside of the thermal spraying booth 119 through the exhaust duct 124. The dust is, for example, a thermal spray material that has not contributed to film formation. The dust may also be a thermal spray material that is melted during thermal spraying and re-solidified by subsequent cooling.

The safety door 125 allows the worker W to enter and exit the thermal spraying booth 119. An interlock of the safety door 125 is controlled by the controller 201.

The centralized control board 101 collectively controls the respective components of the thermal spraying equipment 10 described above. Although not shown, the thermal spraying equipment 10 may include a power supply device that supplies power to each component of the thermal spraying equipment 10. In this case, the centralized control board 101 can control driving of the power supply device.

Although not shown, the thermal spray device 10 may include a compressor that blows air into the thermal spraying booth 119. The compressor blows air into the thermal spraying booth 119 so that dust generated in the thermal spraying booth 119 can be efficiently collected by the dust collector 123. In this case, the centralized control board 101 can control driving of the compressor and an amount of air supplied thereof.

Although not shown, the thermal spraying equipment 10 may include an oxygen concentration sensor that detects oxygen concentration in the thermal spraying booth 119.

As described above, in the present embodiment, the operation of each component of the thermal spraying equipment 10 is collectively controlled by the centralized control board 101. Accordingly, the complexity of the thermal spraying operation can be reduced, and the safety of the operation can be improved. In addition, it is possible to stabilize the quality of the film of the thermal spray material formed on the base material and to improve the reliability of a product.

### [Thermal Spraying Process]

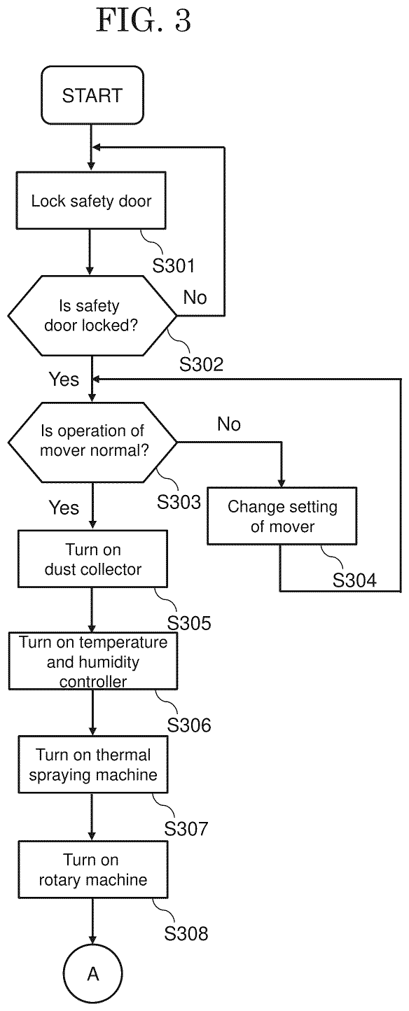

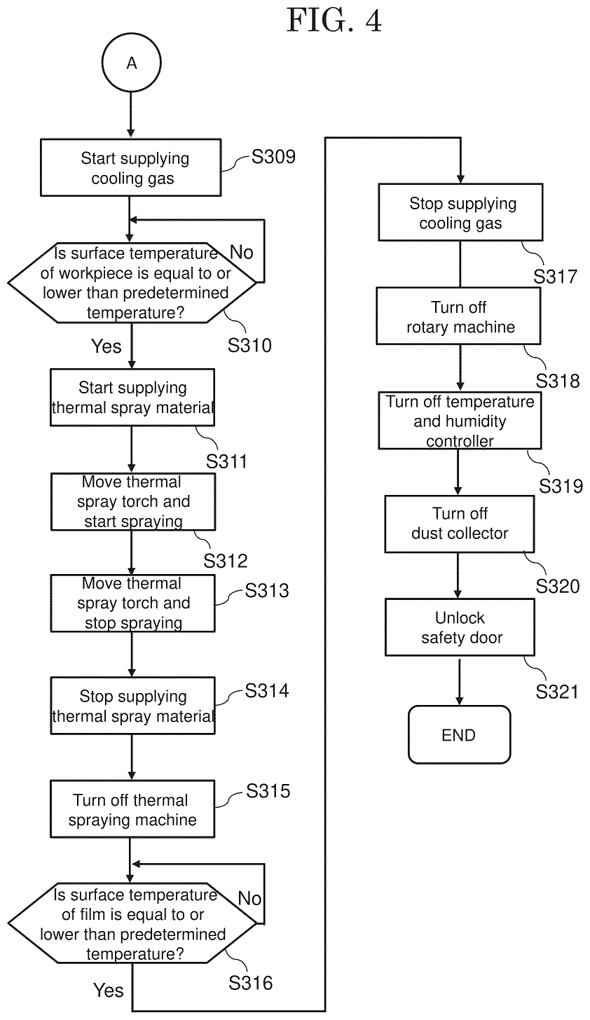

A flow of a thermal spraying process performed by the thermal spraying equipment 10 according to the present embodiment will be described. FIG. 3 and FIG. 4 are flow diagrams showing an example of a thermal spraying process performed by the thermal spraying equipment 10 according to the present embodiment.

The worker W engaged in the thermal spraying operation instructs the start of the thermal spraying process by the thermal spraying equipment 10 via the operation unit 205 of the centralized control board 101. When the thermal spraying process is started, the controller 201 of the centralized control board 101 locks the safety door 125 (S301) so that no one can enter the thermal spraying booth 119 during the thermal spraying process. The controller 201 checks whether the safety door 125 is locked (S302), and in the case where the safety door 125 is not normally locked (S302; No), returns to step S301. Further, although not shown, in the case where a state in which the safety door 125 is not normally locked continues despite an instruction to start the thermal spraying process, the controller 201 may notify the worker W that a problem has occurred in the safety door 125 via the display unit 209.

In the case where the safety door 125 is normally locked (S302; Yes), the controller 201 confirms the operation of the mover 105 (S303). In the case where the operation of the mover 105 is not normal, (S303; No), the worker W confirms the setting of the mover 105 via the operating unit 205 and changes the setting to a desired setting (S304).

In the case where the setting of the mover 105 is normal, that is, in the case where the setting of the mover 105 is a desired setting (S303; Yes), the controller 201 drives the dust collector 123. (S305). Thereafter, the controller 201 drives the temperature and humidity controller 121 (S306). The controller 201 maintains the temperature and humidity in the thermal spraying booth 119 at a predetermined temperature and a predetermined humidity by the temperature and humidity controller 121 based on the temperature and humidity in the thermal spraying booth 119 measured by the second sensor 117.

Subsequently, the controller 201 drives the thermal spraying machine 103 (S307). At this time, the supply of the working gas is also started from the gas feed machine 108 via the thermal spraying control machine 106. Next, the controller 201 drives the rotary machine 113 (S308). When the rotary machine 113 is driven, the workpiece 111 starts rotating at a predetermined speed or at a predetermined angle and a predetermined speed.

In addition, the respective processes from the driving of the dust collector 123 (S305) to the driving of the rotary machine 113 (S308) may be performed in a different order or simultaneously.

The controller 201 then starts supplying the cooling gas from the cooling gas feed machine 109 to the workpiece 111 (S309).

The controller 201 acquires the temperature of the surface of the workpiece 111, that is, the surface on which the coating film is formed by the thermal spray material, measured by the first sensor 115, and determines whether or not the temperature of the surface of the workpiece 111 is equal to or lower than a predetermined temperature (S310). In the case where the surface of the workpiece 111 exceeds the predetermined temperature (S310; No), the controller 201 repeats step S310 until the temperature of the surface of the workpiece 111 becomes equal to or lower than the predetermined temperature.

In the case where the surface of the base material (workpiece 111) is at or below a predetermined temperature (S310; Yes), the controller 201 starts supplying the thermal spray material from the raw material feeder 107 to the thermal spraying torch 102 via the thermal spraying control machine 106 (S311). Next, the thermal spraying torch 102 is moved to a predetermined position by the mover 105, and the thermal spray material is sprayed onto the workpiece 111 to start thermal spraying (S312). Here, the predetermined position is a position where the thermal spraying torch 102 is close to the workpiece 111 of the rotary machine 113. In addition, the controller 201 may tilt the thermal spraying torch 102 at a predetermined angle relative to the surface of the workpiece 111 by the mover 105. A coating film with a predetermined film thickness of the thermal spray material is formed on the surface of the workpiece 111 by the thermal spraying.

When the coating film is formed on the surface of the workpiece 111 with the predetermined film thickness, the controller 201 stops the thermal spraying by moving the thermal spraying torch 102 away from the workpiece 111 of the rotary machine 113 using the mover 105 (S313).

The controller 201 stops the supply of the thermal spray material from the raw material feeder 107 to the thermal spraying torch 102 via the thermal spraying control machine 106 (S314). Next, the controller 201 stops the driving of the thermal spraying machine 103 (S315). At this time, the supply of the working gas from the gas feed machine 108 via the thermal spraying control machine 106 is also stopped.

The controller 201 acquires the temperature of the surface of the workpiece 111, that is, the surface of the coating film made of the thermal spray material, measured by the first sensor 115, and determines whether or not the temperature of the surface of the coating film is equal to or lower than a predetermined temperature (S316). In the case where the surface of the coating film exceeds the predetermined temperature (S316; No), the controller 201 repeats step S316 until the temperature of the surface of the coating film becomes equal to or lower than the predetermined temperature.

When the temperature of the surface of the coating film becomes equal to or lower than the predetermined temperature (S316; Yes), the controller 201 stops the supply of the cooling gas from the cooling gas feed machine 109 to the workpiece 111 (S317).

Thereafter, the controller 201 stops the driving of the rotary machine 113 (S318).

Thereafter, the controller 201 stops the driving of the temperature and humidity controller 121 (S319), and stops the driving of the dust collector 123 (S320). The driving stop of the temperature and humidity controller 121 (S319) and the driving stop of the dust collector 123 (S320) may be performed in a different order or at the same time.

Finally, the controller 201 unlocks the safety door 125 (S321) and ends the thermal spraying process by the thermal spraying equipment 10.

As described above, the thermal spraying process performed by the thermal spraying equipment 10 is collectively controlled by the centralized control board 101. Accordingly, the complexity of the thermal spraying operation can be reduced, and the safety of the operation can be improved. In addition, it is possible to stabilize the quality of the film of the thermal spray material formed on the base material and to improve the reliability of the product.

Based on the embodiments of the present disclosure described above, additions, deletions, or design changes made by a person skilled in the art are also included in a scope of the present invention as long as the present invention is provided.

In addition, it is to be understood that the present invention provides other operational effects that are different from operational effects provided by aspects of the embodiments described above, and those that are obvious from descriptions of the present specification or those that can be easily predicted by a person skilled in the art.

What is claimed is:

1. A thermal spraying equipment comprising:
a thermal spraying machine including a thermal spraying torch thermally spraying a material onto a base material;
a thermal spraying booth where thermal spraying machine is arranged;
one or more peripheral devices used with the thermal spraying machine;
a safety door separating an inside and an outside of the thermal spraying booth; and
a centralized control board arranged outside of the thermal spraying booth, the centralized control board enabling centralized operation of the thermal spraying machine and the one or more peripheral devices,
wherein the centralized control board controls the spraying machine not to be driven in the case where the safety door is not locked normally.

2. The thermal spraying equipment according to claim 1, wherein the oner or more peripheral devices include at least one selected from a group including a mover moving the thermal spraying torch, a raw material feeder supplying the material, a rotary machine fixing and rotating the base material, a temperature and humidity controller controlling temperature and humidity in a thermal spraying booth, a temperature and humidity sensor detecting temperature and humidity in the thermal spraying booth, an oxygen concentration sensor detecting oxygen concentration in the thermal spraying booth, a radiation temperature sensor detecting temperature on the base material, a cooling gas feed machine cooling the base material, and a dust collector collecting dust generated in the thermal spraying booth.

3. The thermal spraying equipment according to claim 1, wherein the centralized control board includes a controller that collectively controls the thermal spraying machine and the one or more peripheral devices.

4. The thermal spraying equipment according to claim 2, wherein the centralized control board includes a controller that collectively controls the thermal spraying machine and the one or more peripheral devices.

5. The thermal spraying equipment according to claim 4, wherein the controller controls the temperature and humidity controller based on a detection result of the temperature and humidity sensor.

6. The thermal spraying equipment according to claim 4, wherein the controller controls the cooling gas feed machine based on a result of the radiation temperature sensor.

7. The thermal spraying equipment according to claim 1, wherein the controller controls locking of the safety door.

8. A thermal spraying control method performed by a thermal spraying machine including a thermal spraying torch spraying a material to a base material, a thermal spraying booth where thermal spraying machine is arranged, one or more peripheral devices used with the thermal spraying machine, a safety door separating an inside and an outside of the thermal spraying booth, and a centralized control board arranged outside of the thermal spraying booth, the thermal spraying control method comprising:
collectively controlling the thermal spraying machine and the one or more peripheral devices using the centralized control board; and
controlling the thermal spraying machine not to be driven in the case where the safety door is not locked normally.

9. The thermal spraying control method according to claim 8, wherein the one or more peripheral devices include at least one selected from a group including a mover moving the thermal spraying torch, a raw material feeder supplying the material, a rotary machine fixing and rotating the base material, a temperature and humidity controller controlling temperature and humidity in a thermal spraying booth, a temperature and humidity sensor detecting temperature and humidity in the thermal spraying booth, an oxygen concentration sensor detecting oxygen concentration in the thermal spraying booth, a radiation temperature sensor detecting temperature on the base material, a cooling gas feed machine cooling the base material and a dust collector collecting dust generated in the thermal spraying booth.

10. The thermal spraying control method according to claim 9, wherein the centralized control board includes a controller that collectively controls the thermal spraying machine and the one or more peripheral devices, the thermal spraying control method comprising:
in response to receiving an instruction to start a thermal spraying operation, checking the safety door is locked normally or not;
in the case where the safety door is locked normally, maintaining temperature and humidity in the thermal spraying booth at a predetermined temperature and a predetermined humidity by the controller, based on a detection result of the temperature and humidity sensor; determining whether a surface temperature of the base material is below a predetermined temperature by the controller, based on a detection result of the radiation temperature sensor; and
in the case where a result of the determination is that the surface temperature of the base material is below the predetermined temperature, driving the thermal spraying machine by the controller to form a coating including the material on the surface of the base material.

11. The thermal spraying control method according to claim 10, further comprising, after the coating is formed, supplying cooling gas to the coating by controlling the cooling gas supply machine, by the controller, until a surface temperature of the coating formed on the base material is below a predetermined temperature based on the detection result of the radiation temperature sensor.

12. The thermal spraying control method according to claim 10, further comprising, in response to receiving the instruction to start the thermal spraying operation, locking the safety door by the controller.
